(19) United States
(12) Patent Application Publication
(10) Pub. No.: US 2005/0013237 A1
(43) Pub. Date: Jan. 20, 2005

(54) Packaging ribbon capable of recording a digital message

(76) Inventor: John Chuang, South Pasadena, CA (US)

Correspondence Address: Wendell J. Jones;PMB 441, 555 Bryant Avenue, Palo Alto, CA, 94301, US

(21) Appl. No.: 10/621,754

(22) Filed: Jul. 18, 2003

(51) Int. Cl. G11B 5/02

(52) U.S. Cl. 369/292

(57) ABSTRACT

The present invention includes a packaging ribbon for use with packages, floral arrangements and the like. In an embodiment, the packaging ribbon includes a digital module capable of recording a personal voice message. Accordingly, a user can record a personal message/salutation on the digital module and utilize the packaging ribbon to include the message/salutation with the package or floral arrangement. A receiver of the package can then listen to the personal message/salutation of the sender when she gets the package. Accordingly, the use of the present invention can enhance a gift by adding a unique personal aspect to the gift. An aspect of the present invention is an article of manufacture. The article includes a fabric material and a digital module coupled to the fabric material wherein the digital module is sewn into a portion of the fabric material.

### FIELD OF THE INVENTION

The present invention relates generally to packaging products and more particularly to a packaging ribbon capable of recording a digital message,

### BACKGROUND OF THE INVENTION

Ribbons and decorative bows are known for use to provide decorative enhancement for gift articles and floral arrangements particularly for special occasions such as anniversaries, birthdays, Valentines day, etc.

While gift wrapping paper, ribbon and, more recently, pre-tied bows have been used to provide aesthetically pleasing effects for gifts, there is continuing demand for improved and even more pleasing effects for association with gift packages, floral arrangements and the like. Indeed, consumers exhibit an almost insatiable appetite for more personalized aspects that add a unique and special touch to gifts that are being sent on certain special occasions.

Accordingly, what is needed is an invention that is capable of providing a unique and personalized aspect to the exchange of gifts and other items of special significance. The invention should be simple, inexpensive and capable of being adapted to existing technology. The present invention addresses these needs.

### SUMMARY OF THE INVENTION

The present invention includes a packaging ribbon for use with packages, floral arrangements and the like. In an embodiment, the packaging ribbon includes a digital module capable of recording a personal voice message. Accordingly, a user can record a personal message/salutation on the digital module and utilize the packaging ribbon to include the message/salutation with the package or floral arrangement. A receiver of the package can then listen to the personal message/salutation of the sender when she gets the package. Accordingly, the use of the present invention can enhance a gift by adding a unique personal aspect to the gift.

A first aspect of the present invention is an article of manufacture. The article includes a fabric material and a digital module coupled to the fabric material wherein the digital module is sewn into a portion of the fabric material.

A second aspect of the present invention is a packaging ribbon. The packaging ribbon includes a fabric material, a digital module coupled to the fabric material and an activation mechanism coupled to the digital module wherein the digital module and the activation mechanism are sewn into a portion of the fabric material.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of an article of manufacture in accordance with an embodiment of the present invention.

FIG. 2(a) shows a top perspective view of the article in accordance with an embodiment of the present invention.

FIG. 2(b) shows a side perspective view of the article in accordance with an embodiment of the present invention.

FIG. 3 shows a packaging ribbon in accordance with an embodiment of the present invention.

FIG. 4 shows an illustration of the system in accordance with another embodiment of the present invention.

FIG. 5(a) shows a front view of the components of the article in accordance with another embodiment of the present invention.

FIG. 5(b) shows a back perspective view of the printed circuit board in accordance with another embodiment of the present invention.

FIG. 5(c) shows a side perspective view of the components in accordance with another embodiment of the present invention.

FIG. 6 shows a packaging ribbon in accordance with another embodiment of the present invention.

### DETAILED DESCRIPTION

The present invention relates to a packaging ribbon. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

The present invention includes an article of manufacture for use with packages, gifts floral arrangements and the like. In an embodiment, the article of manufacture is a packaging ribbon that includes a digital module capable of recording a personal voice message. Accordingly, a user can record a personal message/salutation on the digital module and utilize the packaging ribbon to include the message/salutation with the package or floral arrangement: A receiver of the package can then listen to the personal message/salutation of the sender when she gets the package. Accordingly, the use of the present invention can enhance a gift by adding a unique personal aspect to the gift.

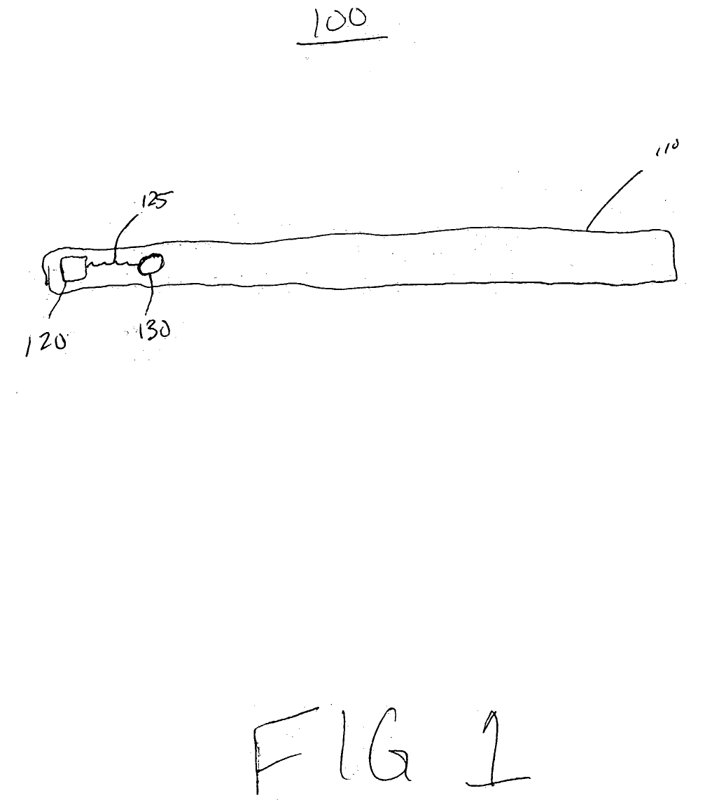

FIG. 1 shows an article of manufacture 100 in accordance with an embodiment of the present invention. The article 100 includes a piece of fabric 110, a digital module 120 and an activation mechanism 130. In an embodiment, the fabric 110 is a ribbon or polyester-type material. One of ordinary skill in the art will readily recognize however that a variety of different materials could be utilized while remaining within the spirit and scope of the present invention.

The digital module 120 is coupled to the activation mechanism 130 via electrical circuitry 125 or other suitable means. In an embodiment, the digital module 120 is a recording module that is capable of recording and playing a voice message via a memory component within the module. These features are controlled through the use of the activation mechanism 130.

Preferably, the activation mechanism 130 is a button-type mechanism whereby the recording/play back features of the digital module 120 are activated/deactivated by depressing the activation mechanism 130. For example, if a user of the article 100 wants to record a message, he could press and hold the activation mechanism 130 while recording the message. An audio cue, such as short “beep’ could be implemented in order to let the user know that the digital module is ready to record a message. Once the message is recorded, the message can be played back by simply pressing the activation mechanism 130.

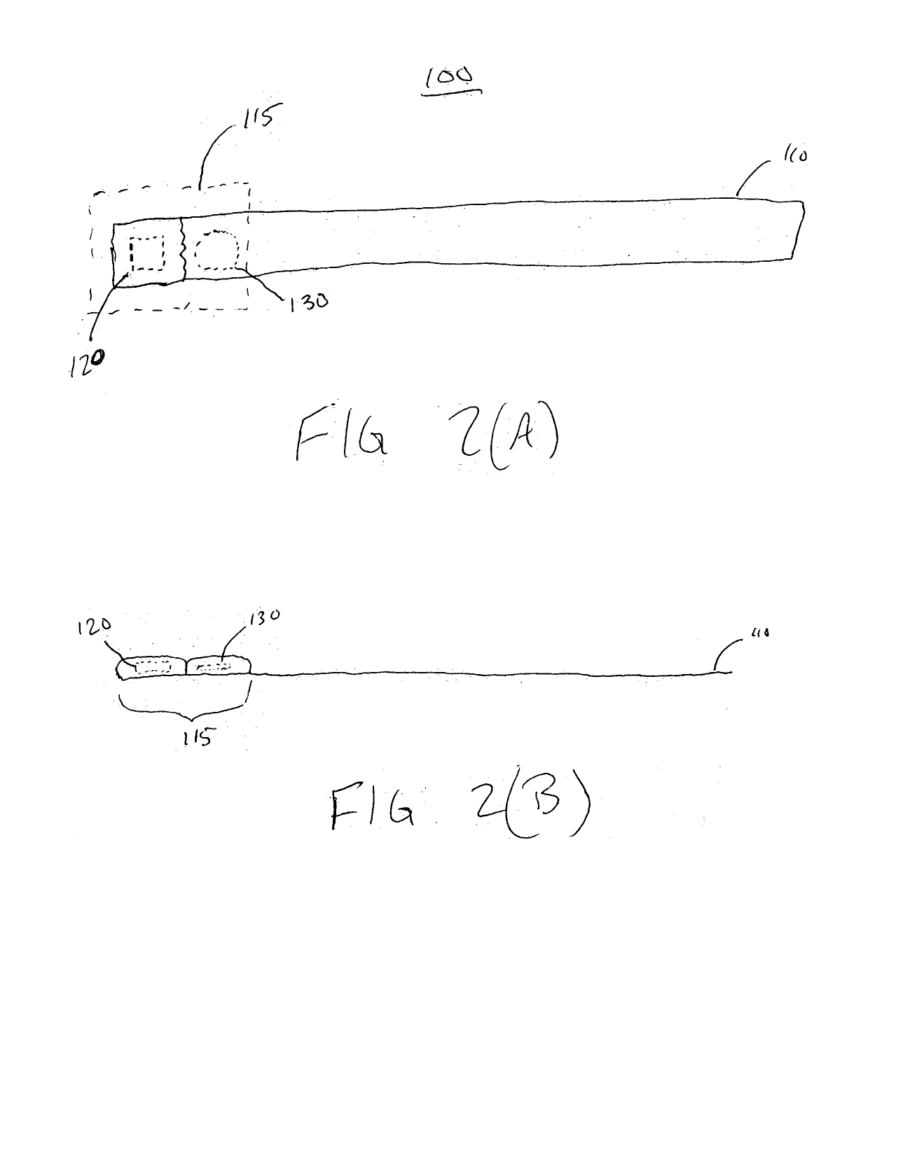

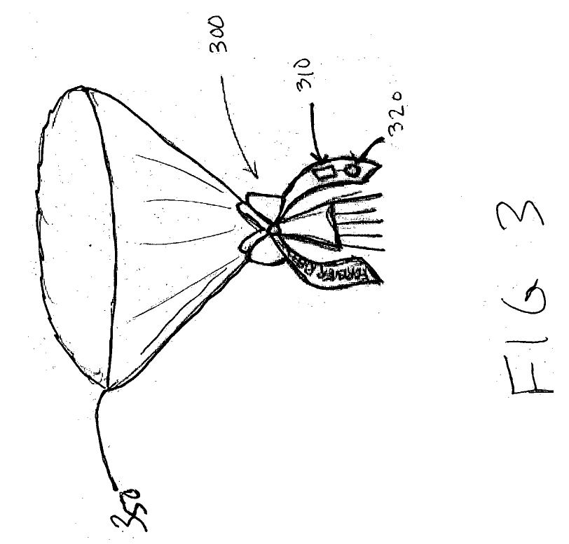

According to an embodiment of the present invention, the digital module 120 and the activation mechanism 130 are sewn into a portion of the fabric 110. Preferably, the digital module 120 and the activation mechanism 130 are sewn into an end portion of the fabric 110. FIG. 2(a) shows a top perspective view of the article 100 wherein the digital module 120 and the activation mechanism 130 are sewn into an end portion 115 of the fabric 110. FIG. 2(b) shows a side perspective view of the article 100 also showing the end portion 115, the digital module 120 and the activation mechanism 130.

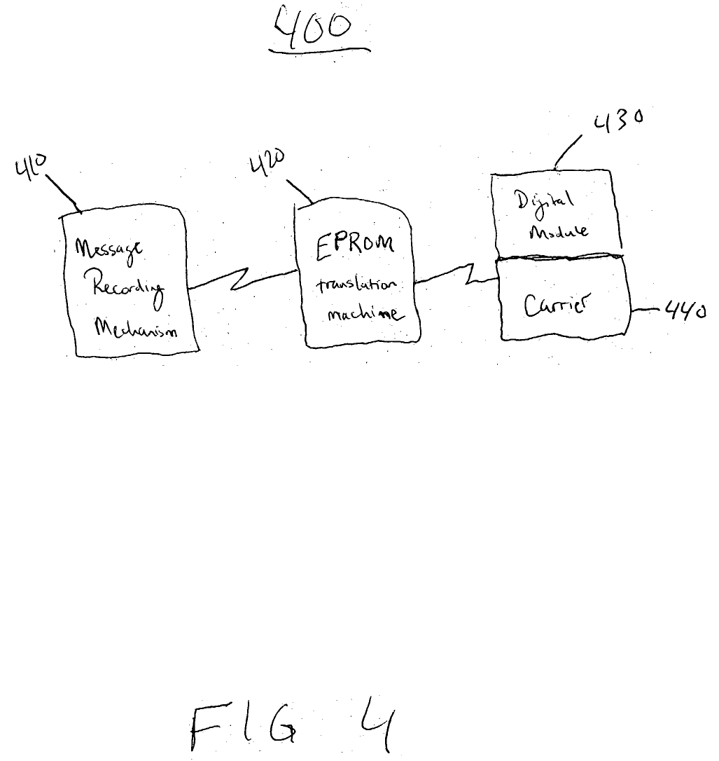

In an embodiment, the article 100 is a packaging ribbon that can be utilized in conjunction with items such as parcels, gifts, floral arrangements and the like to add a unique aspect to the item. FIG. 3 shows a packaging ribbon 300 in accordance with an embodiment of the present invention. FIG. 3 shows the packaging ribbon 300 being utilized in conjunction with a floral arrangement 350. The ribbon 300 includes an embedded digital module 310 coupled to an embedded activation button 320. Accordingly, once the recipient of the floral arrangement 350 receives the arrangement 350, she can simply depress the activation button 320 to hear a previously recorded salutation recorded by the sender of the floral arrangement 350.

According to an alternate embodiment of the present invention, the digital module 120 is a music module that is capable of playing a previously recorded melody. Under this embodiment, the music module does not have recording capability and the activation mechanism 130, once depressed, triggers the music module to play the previously recorded melody.

In yet another embodiment of the present invention, system for creating a packaging ribbon is disclosed. According to this embodiment of the present invention, the digital module is a read only memory (ROM) device and the personalized salutation is transmitted to the ROM device from an external device/system. FIG. 4 shows an illustration of the system 400 in accordance with another embodiment of the present invention. The system 400 includes a message recording mechanism 410, an erasable programmable read only memory (EPROM) translation mechanism 420, a digital module 430 and an integrated circuit carrier 440. The message recording mechanism 410 is coupled to the EPROM translation mechanism 420 and the EPROM mechanism 420 is coupled to the carrier 440.

In an embodiment, the message recording mechanism 410 is a mechanism, such as an answering machine or the like, that is capable of receiving and transmitting a personalized digital message. Accordingly, once the message recording mechanism 410 has received a message, the recording mechanism 410 transmits the message to the EPROM translation machine 420 whereby the EPROM translation mechanism 420 applies electrical signals to the data received. These signals are then transmitted to the integrated circuit carrier 440. Digital module 430 is plugged into the carrier 440 and receives those electronic signals representative of the personalized message. The digital module 430 is then placed into a packaging ribbon whereby a recipient can subsequently listen to the personalized message.

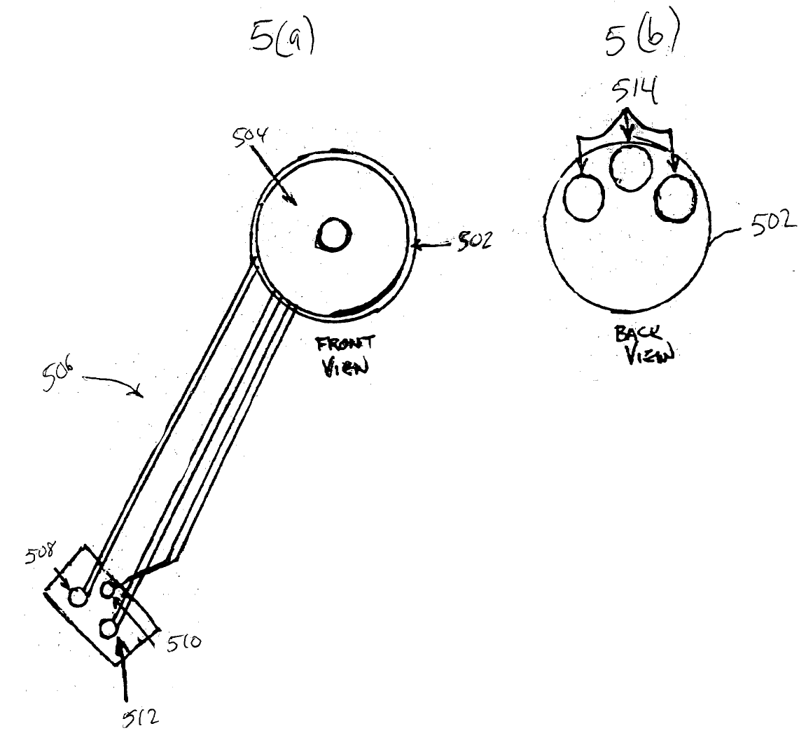

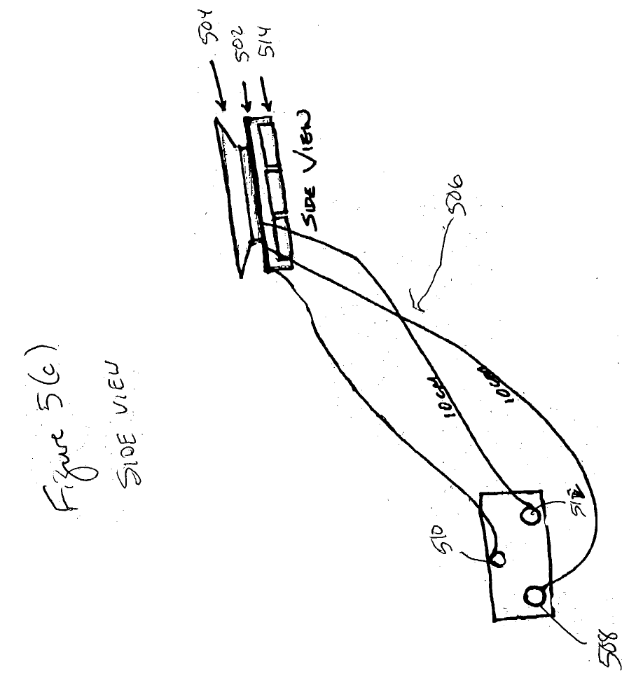

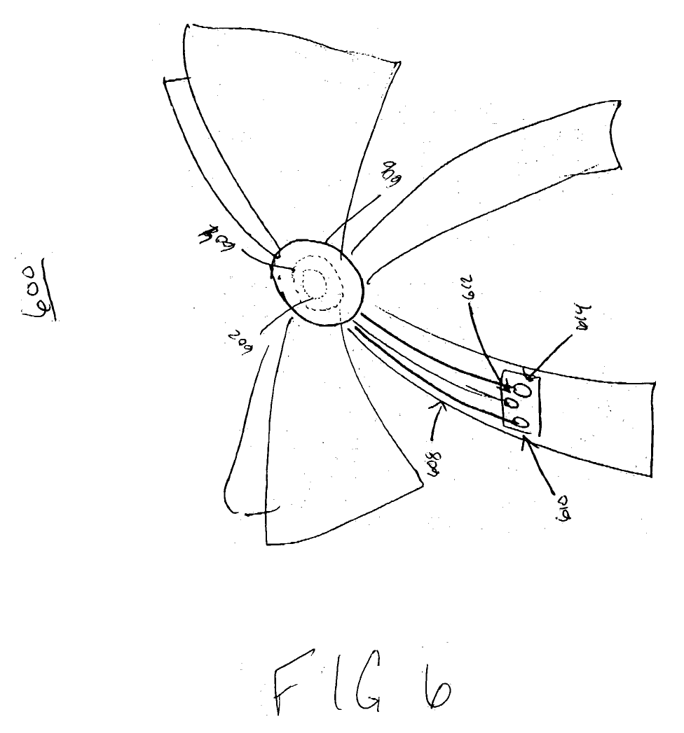

FIG. 5(a)-5(c) show perspective views of yet another embodiment of an article in accordance with the present invention. FIG. 5(a) shows a front view of the components of the article in accordance with another embodiment of the present invention. As can be seen in FIG. 5(a) the components include a printed circuit board (PCB) 502, a speaker 504, plurality of connection wires 506, a record button 508, a microphone 5.10 and a play button 512. The PCB 502 is coupled to the speaker 504 wherein the PCB 502 and the speaker 504 are coupled to the record button 508, the microphone 510 and the play button 512 via the plurality of connection wires 506.

FIG. 5(b) shows a back perspective view of the PCB 502. As can be seen in FIG. 5(b), the PCB 502 includes a plurality of batteries 514. FIG. 5(c) shows a side perspective view of the components. As can be seen, the PCB 502 is coupled to the speaker 504 wherein the PCB 502 and the speaker 504 are coupled to the record button 508, the microphone 510 and the play button 512 via the plurality of connection wires 506.

Accordingly, the above-described components can be employed in a packaging ribbon in accordance with another embodiment of the present invention. FIG. 6 shows a packaging ribbon 600 in accordance with another embodiment of the present invention. The packaging ribbon 600 includes a PCB 602 coupled to speaker 604 wherein the PCB 602 and the speaker 604 are embedded in a fabric material 606. The PCB 602 and the speaker 604 are coupled to a record button 610, a microphone 612 and a play button 614 via a plurality of connection wires 608 wherein the connection wires 608 are embedded in the fabric material.

An article of manufacture for use with packages, gifts, floral arrangements and the like is disclosed. In an embodiment, the article of manufacture is a packaging ribbon that includes a digital module capable of recording a personal voice message. Accordingly, a user can record a personal message/salutation on the digital module and utilize the packaging ribbon to include the message/salutation with the package or floral arrangement whereby receiver of the package can then listen to the personal message/salutation of the sender when she gets the package.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. An article of manufacture comprising:
a fabric material; and
a digital module coupled to the fabric material wherein the digital module is sewn into a portion of the fabric material.

2. The article of claim 1 wherein the fabric material comprises a polyester-type material.

3. The article of claim 1 wherein the fabric material comprises a ribbon-type material.

4. The article of claim 1 further comprising an activation mechanism coupled to the digital module wherein the activation mechanism is sewn into the fabric material.

5. The article of claim 4 wherein the digital module includes a voice recording feature whereby a voice message can be recorded.

6. The article of claim 5 wherein the activation mechanism activates the digital module.

7. The article of claim 6 wherein the activation mechanism activates the voice recording feature.

8. A packaging ribbon comprising:
a fabric material;
a digital module coupled to the fabric material; and
an activation mechanism coupled to the digital module wherein the digital module and the activation mechanism are sewn into a portion of the fabric material.

9. The packaging ribbon of claim 8 wherein the fabric material comprises a polyester-type material.

10. The packaging ribbon of claim 8 wherein the digital module includes a voice recording feature whereby a voice message can be recorded.

11. The packaging ribbon of claim 10 wherein the activation mechanism activates the digital module.

12. The packaging ribbon of claim 11 wherein the activation mechanism activates the voice recording feature.

13. A packaging ribbon comprising:
a fabric material;
a printed circuit board;
a speaker coupled to the printed circuit board;
at least one activation mechanism coupled to the printed circuit board and the speaker; and
wherein the printed circuit board and the speaker are sewn into the fabric material.

14. The packaging ribbon of claim 13 wherein the at least one activation mechanism comprises a play button and a record button.

15. The packaging ribbon of claim 14 wherein the play button and the record button are coupled to the printed circuit board via a plurality of connection wires.
